(19) United States
(12) Patent Application Publication
(10) Pub. No.: US 2010/0300540 A1
(43) Pub. Date: Dec. 2, 2010

(54) METHOD FOR OPERATING A NETWORK OF PIPES

(76) Inventors: Edgar Grosse Westhoff, Beckum (DE); Guenther Strelow, Bochum (DE); Thorsten Kettner, Datteln (DE)

Correspondence Address: KF ROSS PC, 5683 RIVERDALE AVENUE, SUITE 203 BOX 900, BRONX, NY, 10471-0900, US

(21) Appl. No.: 12/438,810

(22) PCT Filed: Aug. 14, 2007
(86) PCT No.: PCT/EP2007/007168

§ 371 Date: Nov. 23, 2009

(30) Foreign Application Priority Data
Sep. 1, 2006 (DE) 10 2006 041 345.8

(51) Int. Cl. F15D 1/00

(52) U.S. Cl. 137/1

(57) ABSTRACT

The invention relates to a method for operating a network of pipes, in particular a network of heating pipes, with several decentralised pumps, each pump being assigned to one heat exchanger. The invention is characterised in that the speed required to achieve the desired and/or stipulated mass flow in each heat exchanger is calculated for each decentralised pump by a central processing unit, taking into account the characteristics of the pipe network, and the speed regulating variable is transmitted to at least some of the decentralised pumps.

The invention relates to a method of operating a pipe network having multiple decentralized pumps, each pump in particular being associated with a respective heat exchanger.

A heat exchanger is generally understood to mean any system used to absorb heat (for cooling purposes) or release heat (for heating purposes). Examples include heating elements (radiators) and surface heat exchangers, such as those used for floor heating or for cooling surfaces, for example.

Furthermore, the association of a decentralized pump with a heat exchanger is understood to mean that one pump, in particular a single pump for each heat exchanger, is provided to move fluid through the heat exchanger. A decentralized pump may be situated in the immediate vicinity of a heat exchanger, as is known in the is configuration of customary thermostat valves, i.e. in the feed line or also in the return line. However, this is not absolutely necessary. A decentralized pump may be situated anywhere in a subnetwork of a pipe network in which at least one decentralized pump and the associated heat exchanger are present. Thus, for example, all decentralized pumps for all heat exchangers may be centrally located, for example in the vicinity of a heat source, in the basement of a building, for example.

Methods of operating pipe networks are generally known in the prior art. Examples include heating pipe networks, for example for heating a building. Such a heating pipe network typically includes a plurality of heat exchangers and at least one heat source, for example a heating furnace, for heating a heating medium, usually water, and circulating this heating medium through the heating pipe network. In the prior art, for purposes of circulation it is basically known to use one, optionally multiple, centralized pumps, in particular in the vicinity of the heating unit, and to regulate the flow rate of each heat exchanger provided in a building by use of actuators, in particular thermostat valves.

In other applications, in this area a change has been made from individual actuators, each associated with a respective heat exchanger, to the use of decentralized pumps, each of which is associated with a respective heat exchanger and located, for example, immediately adjacent to or in the vicinity of a feed or return connector for each heat exchanger. Such a pump may also be only hydraulically associated with a heat exchanger and, for example, be centrally located at a distance from a heat exchanger, in particular together with other pumps. One such decentralized pump performs the function of adjusting the mass flow required in each heat exchanger by modifying the respective pumping speed.

A centralized pump of the type known in the prior art may optionally be omitted entirely, or a centralized pump may act in a supplementary manner together with the individual decentralized pumps. With reference to heating pipe networks, the invention relates to a design in which, instead of thermostat valves, decentralized pumps in each case are associated with the heat exchangers, and in particular one decentralized pump is associated with each heat exchanger.

The invention is not limited to the heating of buildings, and also relates, for example, to any type of pipe network application such as process engineering or air conditioning, i.e. in addition to heating applications, also cooling applications in which a coolant may be circulated through a pipe network and, here as well, a target mass flow may be adjusted using decentralized pumps which are each associated with a cooling element, for example a heat exchanger in a ventilation unit.

For these applications, the measure of the heating or cooling of a space is a function of the particular mass flow provided at a corresponding heating or cooling element.

Thus, for a room-temperature control system, for example, it is known to use room-temperature sensors to detect the current room temperature and to regulate the mass flow of each is decentralized pump to achieve a desired room temperature. If, for example, the current room temperature is lower than a desired room temperature, a decentralized pump will increase its rotational speed for a heating application in order to increase the energy input into the room.

Analogously, for cooling of the room, for the case that the actual room temperature is higher than the desired room temperature, the mass flow would be increased to achieve greater cooling.

In summary, decentralized regulation is performed in which for each of the decentralized pumps the desired temperature and the actual temperature are compared, and on the basis of this comparison the mass flow is adjusted, for example by control the rotational speed, in particular when a mass flow to be adjusted is specified in such a way that the desired temperature is achieved within a desired period of time. Thus, in each room or building unit in which a decentralized pump is associated with a heating or cooling element, the particular mass flow through a decentralized pump is individually regulated, thereby achieving the desired target temperature while taking the current temperature into account.

For such a regulation, sensors for determining the mass flow are usually associated with each of the decentralized pumps. Such a pipe network thus includes a plurality of decentralized sensors. It is also possible to use the electrical operating parameters of the decentralized pumps to compute information concerning the mass flow. Such pumps, in which the hydraulic parameters may be determined from measured electrical parameters, are also referred to as observable pumps.

Furthermore, when decentralized pumps and a decentralized mass flow regulation system are used, a known problem is that when a mass flow for a decentralized pump is changed the mass flows of other decentralized pumps present in the same pipe network may also be automatically influenced, so that changing a mass flow specification in one room, for example to meet other heating or cooling conditions, may also automatically have effects on the heating or cooling conditions in other rooms.

Because of these possible cross influences, when a change is made to a mass flow for one decentralized pump, decentralized regulations are also automatically performed for other decentralized pumps in order to compensate for the influence and restore or maintain the desired heating or cooling conditions in other rooms. In a pipe network having a plurality of decentralized pumps, this may result in an oscillating system which requires a certain response time so that, after an operating parameter has been changed in one or more decentralized pumps, the new operating parameters may also be adjusted for the remaining pumps in order to maintain the previous operating conditions at the remaining pumps.

Thus, for the known regulation systems that are decentralized, it is disadvantageous that on account of the cross influences and the necessary feedback of the control parameters a system operated in this manner on the one hand is slow to respond, in particular with regard to reaching the correct adjusted mass flow and thus for control the room temperature, and on the other hand such a system entails greater complexity of control.

It is therefore the object of the invention to provide a particularly fast-acting and reliable operating method for a pipe network of any type having a plurality of decentralized pumps and in particular heating or cooling elements.

This object is attained according to the invention by the fact that the rotational speed necessary to achieve a desired and/or required mass flow for each heat exchanger is computed for each decentralized pump in particular by a central computing unit, taking into account the characteristics of the pipe network, and the in particular central computing unit transmits the respective computed rotational speed control variable to at least a portion of the decentralized pumps.

The essential core concept of the invention is to dispense with the decentralized regulation for each individual pump, as known heretofore in the prior art, in that each decentralized pump essentially adjusts itself in a decentralized manner to achieve the desired temperatures in a room by changing the respective mass flow.

For this purpose it is essential to know the pipe network characteristics. These pipe network characteristics are understood to mean, for example, the resistances of the line segments present in the pipe network under consideration, and possibly other variables necessary to deterministically describe a pipe network. Thus, by knowing the pipe network characteristics, the mutual influence of the pumps on one another for the particular pipe network under consideration may also be known or at least computed.

In such a case, when the pipe network characteristics and in particular the mutual influence of the pumps of a central computing unit, for example are known or may be computed, which may be associated with a centralized heating or cooling unit, individual decentralized regulation of each decentralized pump is no longer necessary, since because the pipe network characteristics at any time are known, the rotational speed for any decentralized pump necessary to achieve a desired or required mass flow for a pump or heat exchanger may be computed.

Thus, for example, it may be provided that a computing unit performs the computation and/or transmission of the rotational speed parameters according to specified, in particular uniformly spaced, time increments, i.e. periodically.

If no changes are made to the system within a given time period, the rotational speeds already set would be recomputed, whereby it may be provided that, although in effect no change has occurred, these rotational speeds computed in each case are transmitted to the respective pumps, regardless of whether a change occurs as a result.

Rotational speeds are preferably transmitted only to pumps for which a change in the rotational speed results after the transmission. Data traffic may be reduced in this manner.

In another embodiment, which may also be combined with the previous embodiment, it may be provided that a computation and/or transmission takes place after a change in the mass flow requirement has been made for at least one decentralized pump or the associated heat exchanger, for example because a different new temperature in the room is desired.

For example, this may be carried out independently from the previous embodiment or, for example, also when the stated time period has not yet elapsed.

It may be provided that when a mass flow for at least one pump/one heat exchanger is changed, the rotational speeds of the remaining pumps are redetermined, in particular adjusted, to compensate for the mutual influence of the pumps. On the basis of the underlying pipe network characteristics, the mutual influences may be computed and new rotational speeds may thus be determined, which may be transmitted.

By use of the invention, all measures for providing control loops for the mass flow may be dispensed with, since, due to the computation of the rotational speeds for the pumps, for at least a portion of the pumps it is then possible to transmit a new rotational speed control variable directly from the central computing unit.

According to the invention, it is no longer necessary to obtain such a rotational speed control variable by regulation and response of the system; instead, it is possible to compute such a rotational speed control variable and to specify same as a control variable for the decentralized pump in question, in particular without the need for further feedback concerning any control variables, in order to achieve the objective of room-temperature adjustment. This has the further advantage that the decentralized sensors for determining a mass flow (for example, flow or differential pressure sensors) often used in the prior art may be dispensed with, resulting in considerable cost savings.

In this regard, after a time lapse and/or after changing a mass flow for one or more pumps it is not mandatory according to the invention to transmit new rotational speed control variables to all the remaining pumps, since, in particular depending on the pipe network characteristics, especially the pipe network topology, it is possible that each of the remaining decentralized pumps is not affected by a change in the rotational speed. Pumps which do not undergo a change in rotational speed, or for which a change may possibly remain below a specified threshold, may continue to be operated at their previous rotational speeds, so that for these decentralized pumps the transmission of a new rotational speed or rotational speed control variable may be dispensed with.

For such a system, it has proven to be particularly advantageous that, for example, a user may modify desired temperature requirements in a room, and that the overall heating or cooling system does not need time to respond; instead, a central computing unit computes and immediately specifies the new conditions for the decentralized pumps, so that the pipe network or the entire system immediately implements the new operating conditions and achieves a stable state.

Thus, for example, for a heating or cooling application a building may be operated without having to provide measures for feedback of mass flow control variables, since mass flow control variables may be dispensed with, and in each case control variables may be specified for the particular decentralized pumps by a central computing unit or control system. It is only necessary to is regulate the room temperature for which feedback is provided for an actual room temperature.

This feedback from a given room may be provided to a central computing or control unit which uses a desired temperature specification and the actual temperature to compute the mass flow required in the room in question in order to achieve the desired conditions. Based on the required mass flow, the rotational speed may be computed and transmitted to the particular pump.

Instead of a centralized computation (spatially, for example for a cold or heat source) for the mass flow required for a particular pump, each pump may determine or compute the required mass flow in a decentralized manner, based on the desired and actual temperatures, and communicate the required mass flow to a central control system which uses the mass flows present at pumps to compute the particular rotational speeds to be communicated to each pump and transmit this information to the pumps.

In another embodiment, it may be provided that all the pumps are networked, and a basis for computation is present for determining rotational speeds for each of the decentralized pumps. It is thus possible to use any of the decentralized pumps to determine the rotational speeds for all pumps, and to transmit this information to the remaining pumps. Thus, for a control time period any decentralized pump may perform the function of a temporary central control system in the sense of the invention without the need for a centralized control system.

Such a control time period is present, for example, when a user changes a temperature specification in a given room. By means of its associated, in particular implemented, electronics system, the pump which is then affected is able to compute its own new mass flow and new rotational speed, and, as its own temporary control system, also the corresponding variables for all remaining pumps through the network, and to transmit this information to the other pumps.

At the outset it was stated that for the method according to the invention it is important to know the mutual influence of each decentralized pump, for example to have information concerning the effect that a change in rotational speed, and thus in mass flow, for at least one of the pumps from the decentralized pumps as a whole has on the remaining decentralized pumps with regard to their respective mass flow.

To provide this information concerning mutual influence for a control method according to the invention, the mutual influence may be computed, for example, on the basis of a stored pipe network topology, in particular one which is based on stored pump characteristic curves for each pump, the line resistances, and the branch resistances of the pipe network. This embodiment is based on the finding that the physical flow relationships may be deterministically computed when the line resistances and branch resistances of a pipe network are known.

The line resistances and branch resistances are resistances of pipe network segments in the particular pipe network under consideration. For example, the resistances of pipe segments involve the pipe segments in which only a single given decentralized pump is present (end branch), or also line resistances of pipe segments through which some or all of the decentralized pumps mutually pump the particular pumping medium.

If a pipe network of any topology is known with respect to its respective resistances of the individual pipe network segments under consideration, on the basis of the physical relationships between pump delivery heads, mass flows, pump characteristic curves, pressure drops, etc., it is possible to compute the mutual influence of the pumps and thus determine the operating parameters which for the pipe network in question result in a stable and particularly desired operating situation.

It may be provided, for example, that the physical relationship in the consideration of a given pipe network may be stored in corresponding formulas or algorithms of a method implemented by software. Thus, for example, the desired room temperatures for a particular room may be used as input variables for a central computing unit, and then, on the basis of the particular room temperatures, the central computing unit computes the respective mass flows or the rotational speeds which determine them, and by transmitting a rotational speed control variable for the respective decentralized pumps the mass flows necessary for achieving the desired temperatures are set.

If according to the invention the particular temperature requirement changes at one or more of the decentralized pumps, using the method according to the invention it may be provided that the required change in the mass flow, or as an absolute value, the particular required mass flow, for one or more pumps is computed, and based on the respective new mass flow for the pump or pumps in question the influence on the remaining decentralized pumps is computed, and for these pumps as well the new mass flows are set by transmitting a rotational speed control variable.

The method according to the invention includes at least the computation of the desired rotational speeds from specified mass flows. The required mass flows may also be computed within the scope of the method according to the invention, although this is not absolutely necessary. For example, the required mass flows may be computed based on the temperature. This may be carried out in a control circuit for the temperature.

In one aspect of the invention, it may also be provided that a program for implementing the method according to the invention simulates a control circuit as known in the prior art, and transmits the result of the simulated regulation as a control variable to the particular decentralized pumps. Thus, the practical adjustment of a stable operating state is carried out much more quickly using software and computer means, thus allowing the much more quickly obtained end result of the simulated regulation to be transmitted to the decentralized pumps, with practically no oscillating adjustment actually taking place.

In addition to computation of the mutual influence, for example based on taking into account appropriate computation formulas in a software program for carrying out the method, or a simulation, it may be provided that at least one characteristic map, in particular an n-dimensional characteristic map, is stored in a central computing unit, where n represents the number of decentralized pumps. In addition, on the basis of one or more characteristic maps the mutual influence of the pumps may be stored, and by reading out the at least one characteristic map the required operating variables, i.e. in particular the rotational speed control variables, for the particular pumps may be determined for a change in operating point for at least one of the pumps, thus allowing the new rotational speed control variables to be transmitted to the remaining pumps.

In principle, with regard to all possible embodiments a corresponding interface may be provided at each decentralized pump for the transmission of the rotational speed control variables. Thus, for example, the rotational speed control variables may be transmitted by cable or wireless means, or also by optical means. This applies in the same manner for the temperature values, i.e. in this case in particular the actual temperature and the desired target temperature, which may be transmitted to the central computing unit in the same way.

The mutual influence may be easily computed in a particularly advantageous manner when in new buildings, for example, a new pipe network to be installed is designed from the outset and implemented in a building. In this case, as a result of the construction specifications the above-mentioned resistances of the particular pipe network segments under consideration and in particular also the pump characteristic curves of the pumps used are known at the beginning, and may be provided as specified variables in software for implementing a method, for example on a data processing unit, in order to compute the particular rotational speed control variables of the individual decentralized pumps, or to read same from a characteristic map or tables.

In other conceivable applications for which the method is to be transferred to existing pipe networks, and in particular those for which no information is available, it has been found to be advantageous in the method to first determine the pipe network topology in a method step preceding the actual control.

Thus, in principle, it may be provided that the topology of a pipe network, i.e. in particular the resistances of the individual pipe network segments, information concerning branches in the pipe network, and configurations of the decentralized pumps in the pipe network is first determined on the basis of a pipe network analysis, and the results of such a pipe network analysis are stored and used as the basis for computations, or as the basis for forming a readout table or a readout characteristic map. The prior analysis of the affected pipe network also makes it possible to use the method according to the invention for pipe networks for which no information is initially available, for example in old structures under renovation.

To perform such an analysis, it may be provided, for example, that a decentralized pump having a known pump characteristic curve is associated with each end branch of a pipe network, in particular in the same manner as for the subsequent configuration and assignment of decentralized pumps for heating or cooling elements. Within the meaning of the invention, the end branch pipe network segments may be the segments according to the invention in which a heating or cooling element is associated with only one decentralized pump.

It is then possible to carry out an analytical method in which for pairs of pumps, i.e. in each case two given pumps from the total number of decentralized pumps, at least a pair of selected operating states for the pumps is set, and for each pair of operating states the total volumetric flow in the pipe network or the partial volumetric flows in the end branches are determined.

By using such a method in which in each case two pumps are considered in pairs, and certain specified operating states are set for these pumps for analytical purposes, based on the partial pipe network of the overall pipe network formed by the two pumps the respective line resistances of the pipe segments jointly used by the two pumps and the branch resistance of the end branch used by only one of the two pumps may be computed using the variables which are determined, known, and specified by the set operating states.

This embodiment of the invention is based on the consideration that a complex overall pipe network may be iteratively characterized by considering each partial pipe network resulting from the operation of two pumps in each case. Based on the known pump characteristic curves of the two pumps in question and the respective operating parameters, for example the set rotational speeds, the resulting mass flows may then be determined, for example using a centralized sensor or optionally also decentralized mass flow sensors, or also centralized or decentralized observable pumps. Thus, with knowledge of the mass flow and the pump characteristic curves, in each case a conclusion may be drawn concerning the respective resistances of the pipe segments in which the particular decentralized pump under consideration is situated (end branch), and the pipe segments through which the two pumps in question mutually pump the particular fluid.

When the entire pipe network is thus successively analyzed by considering different pairs of pumps in each case, the end result is an overall analysis of the entire pipe network in which the resistances of all pipe network segments present are known, thus allowing this obtained information to be used as the basis of computations for the method according to the invention. A detailed description of a method of analyzing any given pipe network having multiple decentralized pumps is provided in a patent application filed by the applicant on the same date as the present application.

Regardless of whether information about a given pipe network is known from the outset, or an unknown pipe network first undergoes an analysis of the resistances that are present in the respective pipe network segments, the method according to the invention has the advantage that the regulation of decentralized pumps, known in the prior art, may be dispensed with, and by actuating the particular pumps using a respective rotational speed control variable the desired operating state of an entire network may be achieved without regulation.

With regard to all embodiments, it is noted that the technical features stated in conjunction with one embodiment may be used not only for that specific embodiment, but also for the other embodiments. All technical features disclosed in this description of the invention are regarded as essential to the invention, and may be combined in any given manner or used alone.

One embodiment of the invention is described below with reference to the following figures. This example is used only for illustration of the invention, and does not necessarily reflect actual conditions. In the figures:

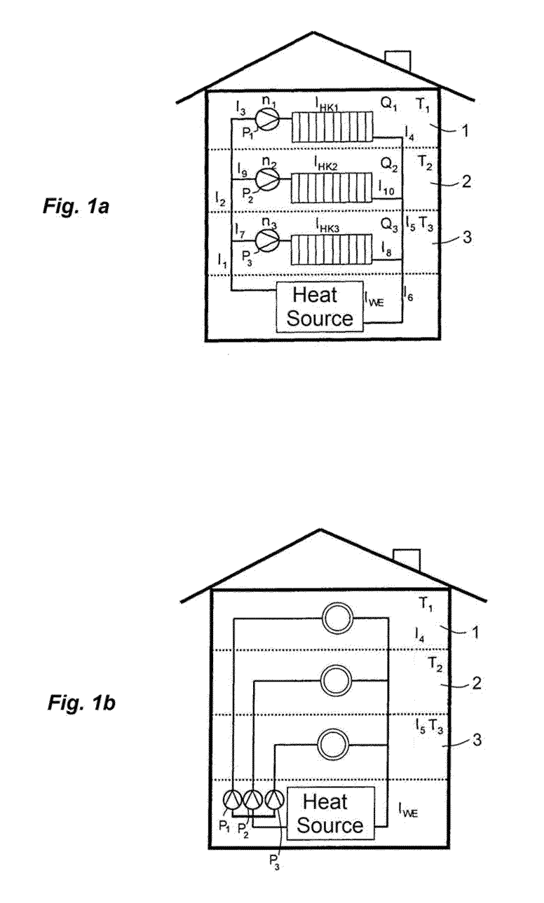

FIG. 1a shows a system of decentralized pumps, each of which is hydraulically and spatially associated with a respective heat exchanger;

FIG. 1b shows a system of decentralized pumps, each of which is hydraulically, but not spatially, associated with a respective heat exchanger;

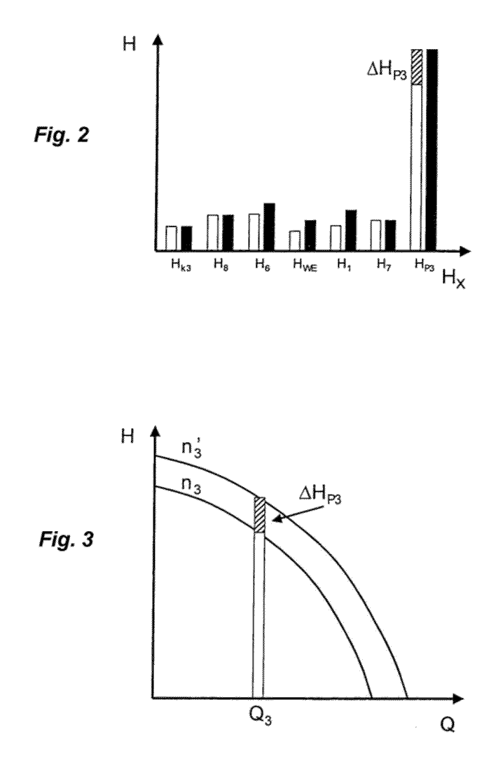

FIG. 2 shows the effect on the pressure relationships due to increasing the volumetric flow; and

FIG. 3 shows a required increase in rotational speed for maintaining the volumetric flow for a pump.

FIG. 1a schematically shows a building having three heaters HK₁₋₃ in the form of heat exchangers, each in a respective room or floor of the building. Located in the feed lines to the heaters HK₁₋₃ are decentralized pumps P₁₋₃ located near the heaters and operated at rotational speeds n₁₋₃, for example 1000, 2000, and 3000 l/min. In this manner heating water is pumped into the corresponding rooms at volumetric flows of Q₁₋₃, for example Q₁=10 L/h, Q₂=20 L/h, and Q₃=30 L/h, which are necessary for maintaining the desired respective room temperatures T₁₋₃.

As an alternative, FIG. 1b shows a system in which the pumps are hydraulically, but not spatially, associated with each heater. All the pumps are located centrally, for example in the basement of a building, for example in the vicinity of a heat source. The configuration and numbering according to FIG. 1a are used for the further explanation of the example.

If a change in a room temperature T, for example an increase in the room temperature T₁ in room 1, is necessary, the volumetric flow Q₁ is increased to 20 L/h, for example, by increasing the rotational speed n₁. This also causes the volumetric flow to increase in the pipelines jointly used by pumps 2 and 3 as well as in the heat source, resulting in an increase in the pressure drop in the pipe network, and thus, a reduction in the volumetric flows Q₂ and Q₃, for example to Q₂=12 L/h and Q₃=25 L/h. This in turn results in a decrease in room temperatures T₂ and T₃.

To maintain the desired temperatures in these rooms it is therefore necessary to increase the rotational speeds n₂ and n₃ in order to once again achieve the original flow values Q₂=20 L/h and Q₃=30 L/h. The increase in volumetric flows Q₂ and Q₃ to the original values causes a reduction in the volumetric flow in heater 1, so that a corresponding readjustment is once again necessary. For a decentralized regulation for each individual pump, as performed heretofore in the prior art, the described mutual influence of the volumetric flows results in a slow reaction time of the overall system.

In contrast, the method according to the invention begins with the starting state Q₁=10 L/h, Q₂=20 L/h, and Q₃=30 L/h and the desired target state Q₁=20 L/h, Q₂=20 L/h, and Q₃=30 L/h and computes the required rotational speeds n₁₋₃, taking into account the possible mutual influence of the volumetric flows, and transmits directly to the pumps the modified rotational speeds n₁₋₃, for example 2200, 2200, and 3150 l/min, which are required for maintaining the desired target state.

One possibility for computing the rotational speeds to be set is described below, first in a general manner, and then for the specific example:

According to

$${H}_{i} = {{I}_{i} ( {\sum }_{for {eachbranch}_{1}} {Q}_{j} )}^{2}$$

the pressure drops in the line segments for which the resistance is equal to I₁ and which are known are specified as the basis for computation. The delivery head to be provided by a pump Pₖ is specified as the sum of all pressure drops in lines which lead to the pump, including the pressure drop for the associated heater. The following relationship applies:

$${H}_{Pk} = {\sum }_{i \text{:} branchio pumpk} {H}_{i}$$

Based on the operating points (Qₖ, Hₖ) for pump k which are now known, the required rotational speed nₖ is determined from the characteristic map. Alternatively, the pump characteristic curve may be parameterized, for example according to H(Q,n)=an²−bnQ−cQ², and the rotational speed calculated according to

$$n = \frac{bQ + \sqrt{{b}^{2} {Q}^{2} + 4 a {cQ}^{2} + 4 aH}}{2 a} .$$

By using the desired (previously computed) pumping flows and the computed pressure drops, this formula computes the required rotational speeds, which are then communicated to the various pumps, for example via lines or also in a wireless or optical manner. The pumps then set the communicated rotational speed without mass flow regulation taking place at the pump itself.

For the specific example, the following relationships apply for the pressure drops in the lines having resistances I, as depicted in FIG. 1a:

H₁=I₁(Q₁+Q₂+Q₃)²

H₂=I₂(Q₁+Q₂)²

H₃=I₃Q₁)²

H₄=I₄Q₁)²

H₅=I₅(Q₁+Q₂)²

H₆=I₆ (Q₁+Q₂+Q₃)²

H₇=I₇Q₃²

H₈=I₈Q₃²

H₉=I₉Q₂²

H₁₀=I₁₀Q₂²

H_{WE}=I_{WE} (Q₁+Q₂+Q₃)²

H_{HK3}=I_{HK3}Q₃²

H_{HK2}=I_{HK2}Q₂²

H_{HK1}=I_{HK1}Q1²

This results in the following for the pump delivery heads:

H_{P1}=H_{HK1}+H₄+H₅+H₆+H_{WE}+H₁+H₂+H₃

H_{P2}=H_{HK2}+H₁₀+H₅+H₆+H_{WE}+H₁+H₂+H₉

H₃=H_{HK3}+H₈+H₆+H_{WE}+H₁+H₇

The effects on the pressure conditions acting on pump P₁ as the result of increasing the volumetric flow Q₁ are illustrated by way of example in FIG. 2. The shaded columns identify the pressure conditions after increasing the volumetric flow Q₁. The pressure drops in the jointly used pipeline segments H₆, H_{WE} and H₁ increase due to the increase in Q₁. The pressure drop in pipeline segments H₇, H_{HK3}, and H₈ remains unchanged. Altogether, in the subnetwork operated by pump P₃ this results in a pressure drop increased by ΔH_{P3}.

An increase in the rotational speed of pump P₃ is necessary for maintaining the volumetric flow Q₃, as schematically illustrated in FIG. 3. The required rotational speed n₃ may be computed based on the provided variables Q₃ and H_{P3}, using the pump characteristic curve or characteristic map, and transmitted as a control variable. The same procedure may be followed for all the other pumps.

1. A method of operating a pipe network having multiple decentralized pumps, each pump being associated with a respective heat exchanger wherein the rotational speed necessary to achieve a desired and/or required mass flow for each heat exchanger is computed for each decentralized pump by a central computing unit, taking into account the characteristics of the pipe network, and the respective computed rotational speed control variable is transmitted to at least a portion of the decentralized pumps.

2. The method according to claim 1 wherein the computation and/or transmission is carried out according to specified time increments.

3. The method according to claim 1 wherein the computation and/or transmission takes place after a change in the mass flow requirement has been made for at least one decentralized pump or the associated heat exchanger.

4. The method according to claim 3 wherein when a mass flow for at least one pump/one heat exchanger is changed, the rotational speeds of the remaining pumps are adjusted to compensate for the mutual influence of the pumps.

5. The method according to claim 1 wherein the other pumps for which the computing unit computes no change in the rotational speed, or for which the computed change is less than a predetermined/predeterminable threshold, are excluded from transmission of a new rotational speed control variable.

6. The method according to one claim 1 wherein at least one of all the decentralized pumps temporarily performs the function of a central computing unit and control system for at least a portion of the other decentralized pumps.

7. The method according to claim 1 wherein the computation is performed on the basis of stored pipe network characteristics including stored pump characteristic curves for each pump, the line resistances, and the branch resistances of the pipe network.

8. The method according to claim 7 claim 7 wherein the pipe network characteristics are determined by performing a pipe network analysis, the results of which are stored and used as the basis for computations.

9. The method of performing a pipe network analysis for a pipe network according to claim 8 wherein a decentralized pump having a known pump characteristic curve is associated with each end branch of a pipe network, wherein for pairs of pumps, in each case at least a pair of selected operating states for the pumps is set, and for each pair of operating states the total volumetric flow in the pipe network or the partial volumetric flows in the end branches are determined, according to which the line resistance of the pipe segments jointly used by both pumps and the branch resistance of the end branch used only by pump are computed using the variables which are determined and specified by the set operating states.

10. The method according to claim 9 wherein the hydraulic characteristics of the entire pipe network are determined from specified variables by iteratively finding jointly used line segments and dividing same into subnetworks.
